(19) United States
(12) Patent Application Publication
(10) Pub. No.: US 2013/0292022 A1
(43) Pub. Date: Nov. 7, 2013

(54) Tire with Thin Sidewalls and Improved Hooping Reinforcement

(71) Applicants: Jacques Morel-Jean, Clermont-Ferrand Cedex 9 (FR); Christophe Le Clerc, Clermont-Ferrand Cedex 9 (FR)

(72) Inventors: Jacques Morel-Jean, Clermont-Ferrand Cedex 9 (FR); Christophe Le Clerc, Clermont-Ferrand Cedex 9 (FR)

(21) Appl. No.: 13/880,970

(22) PCT Filed: Oct. 21, 2011
(86) PCT No.: PCT/EP2011/068406

§ 371 Date: Jul. 26, 2013

(30) Foreign Application Priority Data
Oct. 22, 2010 (FR) 1058661
Feb. 8, 2011 (US) 61440718

(51) Int. Cl. B60C 9/00

(52) U.S. Cl. CPC B60C 9/0042
USPC 152/451

(57) ABSTRACT

A tire (10) with a hooping reinforcement (100) including a part extending axially beyond a crown reinforcement that has NC intersections with any radial plane. A part (41) of the sidewall applied radially between an outer strip (120) and tread (30) is made of a rubber compound that has an elastic modulus E, and a mean thickness EA. The hooping reinforcement (100) is made of a textile material that has a shrinkage force at 180° C. (FC) that is less than or equal to 12 N. Elastic modulus E, mean thickness EA, number of intersections NC and the shrinkage force at 180° C. (FC) are chosen such that for each sidewall of the tire, the following inequality is satisfied:

$$K = ( \frac{E \cdot {EA}^{2} \cdot P}{B \cdot NC \cdot FC} ) < 0.16$$

where P is the thickness of the tire measured in a direction perpendicular to the carcass reinforcement and having an intersection with the axial end of the outer layer of the crown reinforcement, and where B is the curvilinear length of the carcass reinforcement in said part (41) of the sidewall.

### RELATED APPLICATIONS

This is a U.S. national stage of application No. PCT/EP2011/068406, filed on Oct. 21, 2011.

This application claims the priority of French application Ser. No. 10/58661 filed on Oct. 22, 2010 and U.S. Provisional application No. 61/440,718 filed on Feb. 8, 2011, the contents of both of which are hereby incorporated by reference.

### FIELD OF THE INVENTION

The present invention relates to tires for passenger vehicles.

### BACKGROUND

The tires of a vehicle, together with the wheels and axles, form the unsuspended masses of the vehicle. For safety and comfort reasons, vehicle manufacturers are seeking to reduce these unsuspended masses as far as possible. The development of lightweight wheels, in which the weight reduction has been achieved through the use of lightweight materials or lightweight constructions, falls within this context. The tires also constitute a significant proportion of the unsuspended masses and this is why reducing tire weight is a priority for tire manufacturers. Moreover, the mass of a tire translates into a cost in terms of raw materials. If the mass of a tire can be reduced without significantly increasing the cost of the materials used then the reduction in mass will lead to a reduction in the cost price of the tire.

Efforts aimed at reducing the mass of tires naturally reach limits and can give rise to difficulties. When the weight reduction is obtained by making the sidewall thinner, annoying defects of appearance sometimes appear. One of these defects of appearance is that when the tire leaves the curing press, its sidewall has shrunk and forms circumferential ripples. This defect of appearance, also known as rippling, presents no danger to the user of the tire because it disappears when the tire is mounted on its mounting rim and inflated to its service pressure. Nonetheless, it does create difficulties of a psychological nature because the user may have the impression that the tire before him is defective. Because the phenomenon no longer appears once the tire has been deflated following first inflation, it is possible to overcome the problem by systematically inflating and then deflating the tires before selling them, but this solution is cumbersome and expensive to implement. It is therefore essential for a manufacturer to control this phenomenon and prevent it from occurring.

### SUMMARY OF THE INVENTION

One of the objectives of the present invention is to provide a tire with sidewalls that are thinner but do not have the defect of appearance mentioned above when they leave the curing press.

This objective is achieved through a tire comprising two beads configured to come into contact with a mounting rim, each bead comprising at least one annular reinforcing structure, the annular reinforcing structure having, in any radial section, at least one radially innermost point; two sidewalls extending the beads radially outwards, the two sidewalls joining together in a crown comprising a crown reinforcement and a hooping reinforcement, positioned radially on the outside of the crown reinforcement and surmounted by a tread made of at least one first rubber compound.

A carcass reinforcement extends from the beads through the sidewalls as far as the crown, the carcass reinforcement comprising a plurality of carcass reinforcing elements and being anchored in the two beads by turning back around the annular reinforcing structure so as to form, within each bead, a main portion and a wrapped-around portion.

The tire has a median plane which, in any radial section, divides the tire into two tire halves.

Each tire half comprises at least one outer strip made of at least one second rubber compound and positioned at least partially axially on the outside of the wrapped-around portion of the carcass reinforcement, each outer strip extending radially as far as a radially outer end, DI denoting the radial distance between the radially outer end of the outer strip and the radially innermost point of the annular reinforcing structure.

The tread comprises, in any radial section and in each tire half, at least one radially innermost point, DE denoting the radial distance between this radially innermost point of the tread and the radially innermost point of the annular reinforcing structure.

The crown reinforcement comprises a radially inner layer and a radially outer layer, each of the layers being reinforced with threadlike reinforcing elements, the reinforcing elements in each layer being substantially parallel to one another, the reinforcing elements in the two layers being crossed with respect to one another. The radially outer layer of the crown reinforcement extends axially, in each radial section, on each side of the median plane of the tire, between two axial ends of the outer layer, the hooping reinforcement extending axially on each side of the median plane of the tire between two axial ends of the hooping reinforcement such that, in each tire half, the axial end of the hooping reinforcement is situated axially on the outside of the axial end of the outer layer.

The sidewall comprises, in each tire half, a first sidewall part located at radial distances that are greater than or equal to DI and less than or equal to DE from the radially innermost point of the annular reinforcing structure. (In other words, each point of the first sidewall part has a distance from the radially innermost point of the annular reinforcing structure that is greater or equal than DI and less than or equal to DE.) The sidewall part is made of at least one third rubber compound distinct from said at least one first and second rubber compounds from which the tread and the outer strip are made. As a consequence, it is possible to discern the extent of this sidewall portion in relation to the tread and the outer strip of a tire cut. The third rubber compound has an elastic modulus E greater than or equal to 1.5 MPa and less than or equal to 10 MPa, and preferably less than or equal to 3 MPa.

The sidewall has, in the first sidewall part, a mean thickness EA, this thickness being measured perpendicular to the carcass reinforcement.

The hooping reinforcement is made of a textile material having a shrinkage force at 180° C. (“FC”) that is less than or equal to 12 N (and preferably greater than or equal to 3 N and less than or equal to 9 N), the hooping reinforcement being formed of at least one reinforcing element directed circumferentially, the hooping reinforcement having, in any radial section, a plurality of intersections with the plane of section such that, in each tire half, a non-zero number NC of intersections is situated axially on the outside of the axial end of the outer layer of the crown reinforcement.

In a tire according to an embodiment of the invention, the elastic modulus E, the mean thickness EA, the number of intersections NC and the shrinkage force at 180° C. (FC) are chosen such that for each sidewall of the tire, the following inequality is satisfied:

$$K = 100 \cdot ( \frac{E \cdot {EA}^{2} \cdot P}{B \cdot NC \cdot FC} ) < 16$$

where P is the thickness of the tire measured in a direction perpendicular to the carcass reinforcement and having an intersection with the axial end of the outer layer of the crown reinforcement which lies in the same tire half as the sidewall, and where B is the curvilinear length of the carcass reinforcement between (a) a point on the carcass reinforcement that is at a distance DI with respect to the radially innermost point of the annular reinforcing structure, and (b) a point on the carcass reinforcement that is at a distance DE with respect to the radially innermost point of the annular reinforcing structure.

For preference, the elastic modulus E, the mean thickness EA, the number of intersections NC, and the shrinkage force at 180° C. (FC) are chosen such that for each sidewall of the tire, K<11.

For preference, the mean thickness EA is greater than or equal to 2 mm and less than or equal to 5 mm, the number of intersections NC is greater than or equal to 3 and less than or equal to 15, and the thickness P of the tire is greater than or equal to 8 mm and less than or equal to 15 mm.

Providing reinforcements that have a low shrinkage force at 180° C. has the effect of reducing the magnitude of the forces involved and, therefore, of avoiding the defects of appearance which these cause, without, however, altering the mechanical behavior of the crown of the tire.

According to a preferred embodiment, the hooping reinforcement is made of a material for which the force developed at 180° C. at 3% deformation is greater than or equal to 25 N.

For preference, the hooping reinforcement is made of polyester, and more preferably still of PEN (polyethylene naphthalate), PET (polyethylene terephthalate) or PK (polyketone).

PET notably has the advantage of reducing the risk of corrosion damage to the metal cords in the crown reinforcement because reinforcing elements made of PET have lower water retention.

Of course, it may be advantageous to combine several or even all of the preferred embodiments.

### BRIEF DESCRIPTION OF THE DRAWINGS

FIG. 1 depicts a tire according to the prior art.

FIG. 2 depicts a partial perspective view of a tire according to the prior art.

FIG. 3 depicts a radial section through a portion of a tire.

FIG. 4 depicts a radial section through a portion of a tire according to an embodiment of the invention.

FIG. 5 illustrates the concept of “high-temperature shrinkage force”.

FIG. 6 shows the force/elongation curve for four types of textile reinforcing elements.

### DETAILED DESCRIPTION OF THE DRAWINGS

When using the term “radial” it is appropriate to make a distinction between several different ways in which those skilled in the art use that term. First, the expression refers to a radius of the tire. It is within this meaning that a point P1 is said to be “radially inside” a point P2 (or “radially on the inside of” the point P2) if it is closer to the axis of rotation of the tire than is the point P2. Conversely, a point P3 is said to be “radially outside” a point P4 (or “radially on the outside of” the point P4) if it is further from the axis of rotation of the tire than is the point P4. Progress will be said to be being made “radially inwards (or outwards)” when it is being made in the direction of smaller (or larger) radii. Where radial distances are involved, it is this meaning of the term which applies also.

By contrast, a thread or a reinforcement is said to be “radial” when the thread or the reinforcing elements of the reinforcement make an angle greater than or equal to 80° and less than or equal to 90° with the circumferential direction. It should be noted that in this document, the term “thread” is to be understood in its broadest sense and to comprise threads in the form of monofilaments, multifilaments, a cord, a yarn or an equivalent assembly, irrespective of the material of which the thread is made and irrespective of the surface treatment it may have undergone to enhance its bonding with the rubber.

Finally, a “radial cross section” or “radial section” is to be understood here to mean a cross section or section in a plane containing the axis of rotation of the tire.

An “axial” direction is a direction parallel to the axis of rotation of the tire. A point P5 is said to be “axially inside” a point P6 (or “axially on the inside of” the point P6) if it is closer to the median plane of the tire than is the point P6. Conversely, a point P7 is said to be “axially outside” a point P8 (or “axially on the outside of” the point P8) if it is further from the median plane of the tire than is the point P8. The “median plane” of the tire is the plane perpendicular to the axis of rotation of the tire and which is situated midway between the annular reinforcing structures of each bead. When it is said that the median plane in any radial section divides the tire into two tire “halves” that should not be understood to mean that the median plane necessarily constitutes a plane of symmetry of the tire. The expression “tire half” here has a broader meaning and denotes a portion of the tire that has an axial width of about half the axial width of the tire.

A “circumferential” direction is a direction which is perpendicular both to a radius of the tire and to the axial direction.

Within the context of this document, the expression “rubber compound” denotes a rubber compound containing at least one elastomer and one filler.

The “elastic modulus” of a rubber compound is to be understood to mean the secant tensile modulus obtained under traction in accordance with standard ASTM D 412 (1998) (test specimen “C”): one measures the apparent secant moduli at 10% elongation, denoted “MA10” and expressed in MPa (under normal temperature and hygrometric conditions in accordance with ASTM D 1349 (1999)) during the second elongation (that is to say after an accommodation cycle).

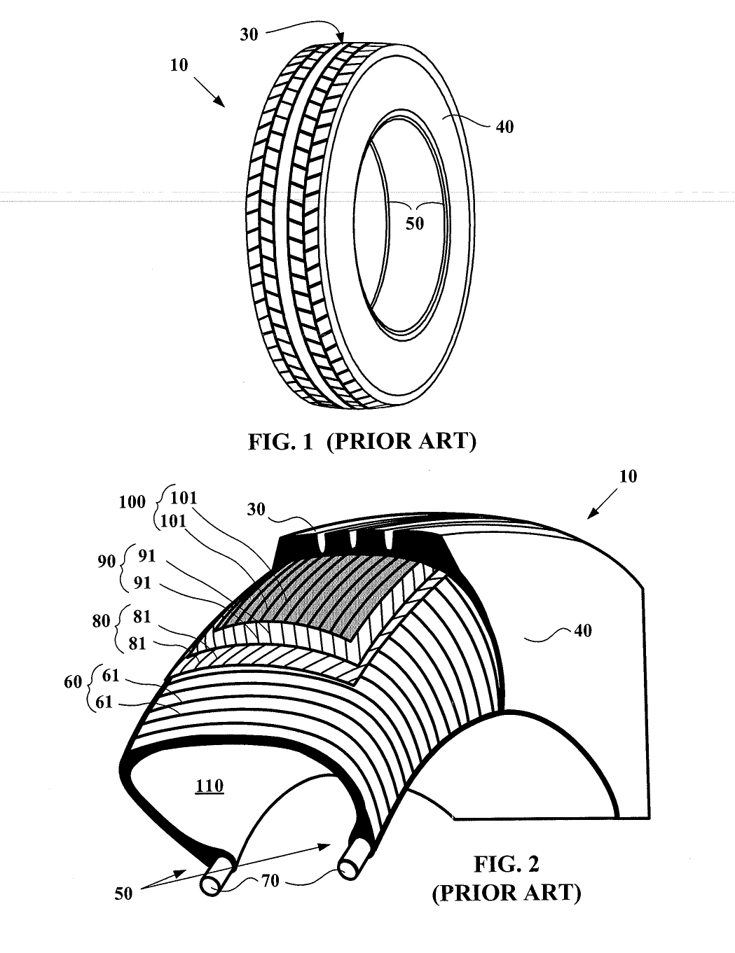

FIG. 1 schematically depicts a tire 10 according to the prior art. The tire 10 comprises a crown comprising a crown reinforcement (not visible in FIG. 1) surmounted by a tread 30, two sidewalls 40 extending the crown radially inwards, and two beads 50 radially on the inside of the sidewalls 40.

FIG. 2 schematically depicts a partial perspective view of another tire 10 according to the prior art and illustrates the various components of the tire. The tire 10 comprises a carcass reinforcement 60 made up of threads 61 coated with rubber compound, and two beads 50 each comprising circumferential reinforcing structures 70 (in this embodiment bead wires) which hold the tire 10 on the rim (not depicted). The carcass reinforcement 60 is anchored in each of the beads 50. The tire 10 further comprises a crown reinforcement comprising two plies 80 and 90. Each of the plies 80 and 90 is reinforced with threadlike reinforcing elements 81 and 91 which are parallel within each layer and crossed from one layer to the other, making angles of between 10° and 70° with the circumferential direction. The tire further comprises a hooping reinforcement 100 positioned radially on the outside of the crown reinforcement, this hooping reinforcement being formed of reinforcing elements 101 directed circumferentially and wound in a spiral. A tread 30 is laid on the hooping reinforcement; it is this tread 30 which provides contact between the tire 10 and the road surface. The tire 10 depicted is a tubeless tire: it comprises an “inner liner” 110 made of a rubber compound impervious to the inflation gas, covering the interior surface of the tire.

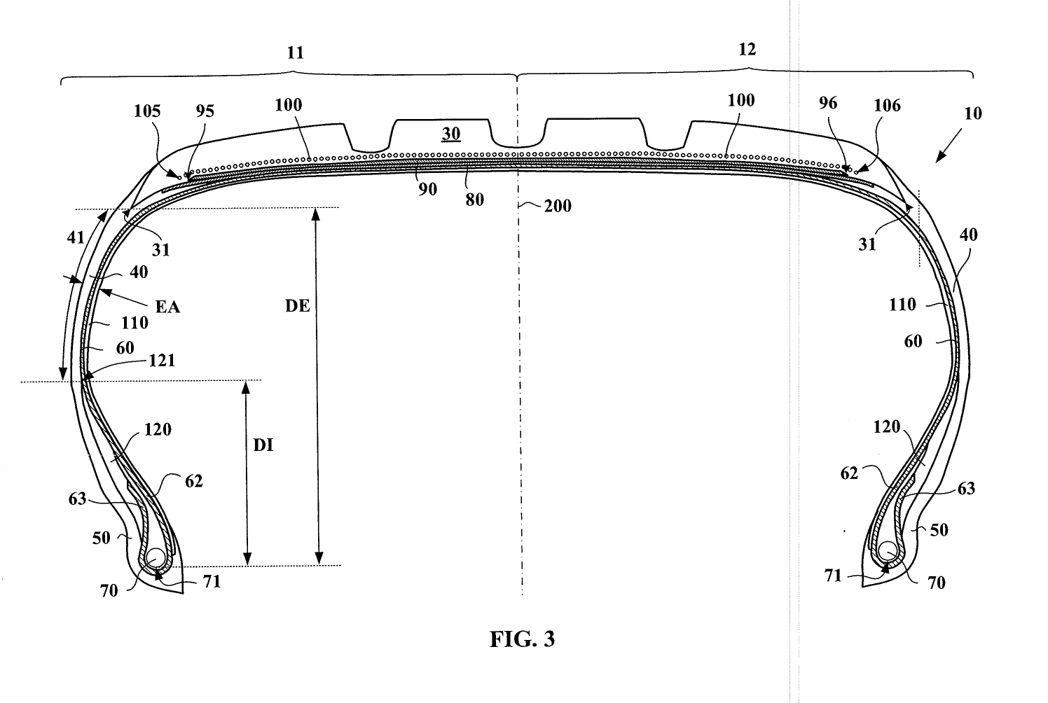

FIG. 3 schematically depicts, in radial cross section, one portion of a tire 10. This tire 10 comprises two beads 50 configured to come into contact with a mounting rim (not depicted). Each bead comprises an annular reinforcing structure 70 (in this embodiment a bead wire). The reference 71 denotes the radially innermost point of the annular reinforcing structure 70.

Two sidewalls 40 extend the beads 50 radially outwards and meet in a crown comprising a crown reinforcement formed by the layers 80 and 90 and a hooping reinforcement 100 positioned radially on the outside of the crown reinforcement and surmounted by a tread 30 made of at least one first rubber compound.

The hooping reinforcement 100 is formed, in a way known to those skilled in the art, of at least one circumferentially directed reinforcing element. The figure shows a plurality of intersections (drawn in the form of circles) between the hooping reinforcement 100 and the plane of section.

The reference 200 denotes the median plane which divides the tire into two halves 11 and 12.

The crown reinforcement comprises a radially inner layer 80 and a radially outer layer 90, each of the layers being reinforced with threadlike reinforcing elements, the reinforcing elements of each layer being parallel to one another, the reinforcing elements of the two layers being crossed with respect to one another.

The radially outer layer 90 of the crown reinforcement extends axially, in each radial section, on each side of the median plane 200 of the tire, between two axial ends 95 and 96 of the outer layer. Likewise, the hooping reinforcement 100 extends axially on each side of the median plane 200 of the tire, between two axial ends 105 and 106 of the hooping reinforcement 100. In each tire half 11 and 12, the axial end of the hooping reinforcement is situated axially on the outside of the axial end of the outer layer.

The tire 10 further comprises a carcass reinforcement 60 running from the beads 50 through the sidewalls 40 as far as the crown. The carcass reinforcement comprises a plurality of carcass reinforcing elements; it is anchored in the two beads by being turned back around the bead wire 70, so as to form, within each bead, a main portion 62 and a wrapped-around portion 63.

Each half 11 and 12 of the tire further comprises an outer strip 120 made of a second rubber compound and positioned at least partially axially on the outside of the wrapped-around portion 63 of the carcass reinforcement 60, each outer strip running radially as far as a radially outer end 121, DI denoting the radial distance between the radially outer end 121 of the outer strip 120 and the radially innermost point 71 of the annular reinforcing structure 70.

The tread 30 comprises, in each half of the tire, a radially innermost point 31, DE denoting the radial distance between this radially innermost point 31 of the tread 30 and the radially innermost point 71 of the annular reinforcing structure 70.

The sidewall 40 comprises, in each tire half, a first sidewall part 41 located at radial distances that are greater than or equal to DI and less than or equal to DE from the radially innermost point of the annular reinforcing structure. Sidewall part 41 is made of at least one third rubber compound distinct from said at least one first and second rubber compounds from which the tread and the outer strip are made. As a consequence, it is possible to discern the extent of this sidewall part in relation to the tread 30 and the outer strip 120 on a tire cut. The third rubber compound has an elastic modulus E that is greater than or equal to 1.5 MPa and less than or equal to 10 MPa.

The sidewall, in the first sidewall part, has a mean thickness EA, this thickness being measured perpendicular to the carcass reinforcement.

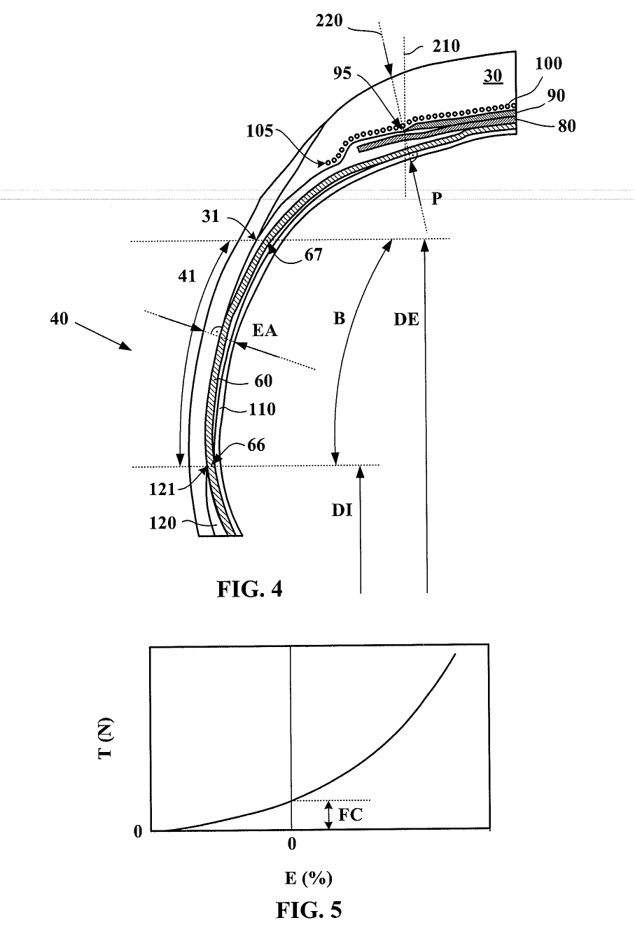

FIG. 4 depicts, in radial section, a portion of a tire according to an embodiment of the invention. Only the portions of the tire showing features that characterize the invention have been shown.

It is possible to discern the axially outer parts of the layers 80 and 90 of the crown reinforcement and of the hooping reinforcement 100, which is positioned radially on the outside of the crown reinforcement and surmounted by a tread 30 made of at least one first rubber compound.

The hooping reinforcement 100 is formed, in a way known to those skilled in the art, of at least one circumferentially directed reinforcing element. The figure shows a plurality of intersections (drawn in the form of circles) between the hooping reinforcement 100 and of the plane of section. It is made of a textile material having a shrinkage force at 180° C. (FC) that is less than or equal to 12 N.

Each of the radially inner layer 80 and radially outer layer 90 that make up the crown reinforcement is reinforced with threadlike reinforcing elements (not shown), the reinforcing elements in each layer being parallel to one another, the reinforcing elements of the two layers being crossed with respect to one another. For preference, in a tire according to an embodiment of the invention, the thread density is greater than or equal to 60 and less than or equal to 125 threads per decimeter.

The radially outer layer 90 of the crown reinforcement extends axially as far as an axial end 95 of the outer layer. Likewise, the hooping reinforcement 100 extends axially as far as an axial end 105 of the hooping reinforcement 100. In a tire according to an embodiment of the invention, in each tire half, the axial end 105 of the hooping reinforcement 100 is situated axially on the outside of the axial end 95 of the outer layer so that, in each tire half, a non-zero number of intersections NC (in this embodiment thirteen intersections) lies axially on the outside of the axial end of the outer layer 90 of the crown reinforcement, the axial position of which is indicated by the line 210.

FIG. 4 also shows the radially outer part of the outer strip 120, made of a second rubber compound. The outer strip extends radially as far as a radially outer axial end 121, DI denoting the radial distance between the radially outer axial end 121 of the outer strip 120 and the radially innermost point 71 of the annular reinforcing structure 70 (not depicted).

Also visible is the radially innermost point 31 of the tread, DE denoting the radial distance between this radially innermost point 31 of the tread 30 and the radially innermost point 71 of the annular reinforcing structure 70 (not depicted).

The sidewall 40 comprises, a first sidewall part (indicated using the double arrows 41), located at radial distances that are greater than or equal to DI and less than or equal to DE from the radially innermost point of the annular reinforcing structure. Sidewall part 41 is made of at least one third rubber compound distinct from said at least one first and second rubber compounds from which the tread 30 and the outer strip 120 are made. The third rubber compound has an elastic modulus E greater than or equal to 1.5 MPa and less than or equal to 10 MPa.

The sidewall, in the first sidewall part, has a mean thickness EA, this thickness being measured perpendicular to the carcass reinforcement 60.

Let P be the thickness of the tire, measured in a direction 220 perpendicular to the carcass reinforcement 60 and intersecting the axial end 95 of the radially outer layer 90 of the crown reinforcement, and let B be the curvilinear length of the carcass reinforcement 60 between (a) a point 66 on the carcass reinforcement 60 situated a distance DI away from the radially innermost point 71 of the annular reinforcing structure 70 (not depicted in FIG. 4) and (b) a point 67 on the carcass reinforcement 60 situated a distance DE away from the radially innermost point 71 of the annular reinforcing structure 70. (In order not to overload FIG. 4, the arrow indicating the curvilinear length B has been axially offset in relation to the carcass 60).

The applicant has noted that the parameter

$$K = 100 \cdot ( \frac{E \cdot {EA}^{2} \cdot P}{B \cdot NC \cdot FC} )$$

is very relevant in detecting the vulnerability of a tire design to the “rippling” phenomenon. In order to obtain a tire that is resistant to this sidewall appearance defect, the elastic modulus E, the mean thickness EA, the number of intersections NC and the shrinkage force at 180° C. (FC) need to be chosen so that, in each sidewall of the tire, K<16 and, more preferably still, K<11.

Let us now describe how the “shrinkage force at 180° C.” FC is determined. In order to determine the force of shrinkage, at high temperatures, of a textile reinforcement, the force-elongation curve of the reinforcement placed in a furnace set to a constant temperature of 180±0.5° C. is determined. FIG. 5 shows an example of a curve that might be obtained.

More specifically, the reinforcement is placed under very light pretension (0.5 cN/tex), then the reinforcement is heated to a temperature of 180° C., maintaining the pretension. When the temperature is reached, tension is applied to the thread.

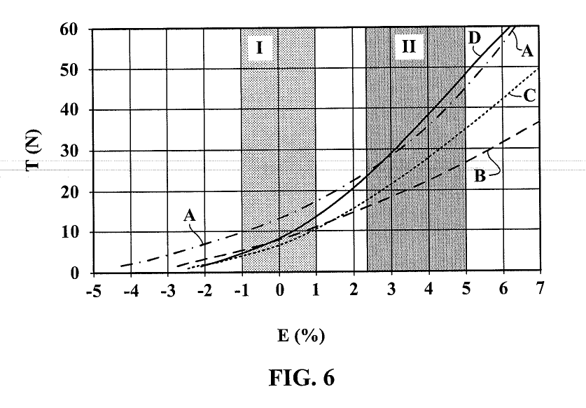

Note that unlike the more conventional force-elongation curves which are determined at ambient temperature, the curves set out in FIGS. 5 and 6 have been obtained at 180° C. As the reinforcements shrink under the influence of temperature and revert to their initial length only when they have been tensioned, the elongation E, in terms of the length of the reinforcement at ambient temperature, is negative at zero tension T. The value of the elongation at zero tension T correlates directly with the “thermal shrinkage potential” of the reinforcement used.

The shrinkage force at 180° C. (FC) is defined as being the force developed as the specimen reverts to 0% deformation. Another important parameter is the force developed at around 3% deformation because, bearing in mind the temperature and centrifugal effects generated by speed, this is a typical operating point of the tire running at its maximum speed, that is to say at the highest speed at which the tire can run without sustaining damage.

The “thermal shrinkage potential” (CC) is a parameter well known to those skilled in the art and expresses the relative variation in length of a reinforcement positioned under a pretension of 0.5 cN/tex (remember that 1 cN/tex is equal to 0.11 gram/denier) between the plates of a furnace (equipment of the Testrite type) set to a constant temperature of 185±0.5° C. The thermal shrinkage potential is expressed in via the following formula:

$$CC [ \% ] = 100 \cdot \vert \frac{{L}_{0} - {L}_{1}}{{L}_{0}} \vert$$

where L₀ is the initial length of the reinforcement at ambient temperature and L₁ is the length of this same reinforcement at 185° C. The length L₁ is measured after the reinforcement has stabilized for a period of 120 s±2% at 185° C. For textile reinforcements, the thermal shrinkage potential is the result of all of the operations that the reinforcement underwent while it was being produced or worked.

Most of the textiles customarily used as reinforcing elements in passenger car tire hooping reinforcements have a relatively high shrinkage force and a relatively high thermal shrinkage potential. Thus, the nylon cords (2×140 tex) marketed by the company Yarnea have a thermal shrinkage force of about 14 N and a thermal shrinkage potential of 10.7%.

It should be noted that the values claimed for the shrinkage force at 180° C. are obtained on reinforcements before they are incorporated into the tire. In theory, it is also possible to determine the shrinkage force of a reinforcement after it has been extracted from the tire, but it then becomes necessary to take measurements from threads extracted from the median plane of the tire because at this point the presence of the crown reinforcement greatly reduces the changes in microstructure during curing and the cooling that follows, which means that the values of FC and CC remain the same.

Good results have been obtained with reinforcing elements made of polyester. In the polyester category, mention may, for example, be made of PET (polyethylene terephthalate, PEN (polyethylene naphthalate), PBT (polybutylene terephthalate), PBN (polybutylene naphthalate), PPT (polypropylene terephthalate), PPN (polypropylene naphthalate).

FIG. 6 shows the force/elongation curve for four types of textile reinforcing elements. It gives the values of tension (in N) needed to obtain a certain elongation (in %) at a temperature of 180° C. The figures particularly highlight two elongation domains: the low elongation domain indicated by “I” is the domain of the elongations through which the reinforcements pass during the manufacture of the tires; the domain indicated by “II” corresponds to the domain in which the hooping reinforcement is situated when the tire is in use and therefore determines the effectiveness of the hooping reinforcement. The gradient of the force-elongation curve for a reinforcing element corresponds to the modulus of the reinforcing element. In order to act as a hooping reinforcement without jeopardizing the manufacturing method, a reinforcing element needs to develop a low force in domain I and to develop a significant force in domain II.

Table I indicates the nature of the reinforcing elements, the force-elongation curves of which are given in FIG. 6:

TABLE I

| Curve | Line style | Material | Structure | TPM [1] | FC [N] | CC [%] |
|---|---|---|---|---|---|---|
| “A” | dash- | nylon | 2 × 140 | 250 | 13.4 | 7 |
| | dotted | | tex | | | |
| “B” | dashed | nylon | 2 × 140 | 250 | 8.0 | 3.7 |
| | | | tex | | | |
| “C” | dotted | PET | 2 × 110 | 470 | 8.6 | 2.2 |
| | | | tex | | | |
| “D” | solid | PET | 2 × 144 | 420 | 6.8 | 2.2 |
| | | | tex | | | |

[1] turns per meter

As can be seen clearly in FIG. 6, the reinforcing elements of type “C” and “D” make it possible to obtain forces comparable with the reinforcing element of type “A” in domain II and a markedly lower force than the type “A” reinforcing element in domain I, and this is beneficial in reducing sidewall rippling, whereas the reinforcing element of type “B” develops a force similar to that of the type “C” and “D” reinforcing elements in domain I, but also develops a lower force in domain II and will therefore be less effective as a reinforcing element for the hooping reinforcement.

Table II shows the results obtained for various tires and allows the relevance of the choice of the criterion K to be assessed:

TABLE II

| | | E | EA | P | B | | FC | | FR |
|---|---|---|---|---|---|---|---|---|---|
| Tire | Size | [MPa] | [mm] | [mm] | [mm] | NC | [N] | K | [1] |
| 1 | 205/55 R 16 | 2.37 | 4.7 | 12 | 40.0 | 13 | 1.34 | 9 | F |
| 2 | 205/55 R 16 | 2.31 | 3.9 | 12 | 40.3 | 10 | 1.34 | 8 | F |
| 3 | 225/55 R 16 | 2.36 | 4.5 | 12 | 34.7 | 13 | 1.34 | 9 | F |
| 4 | 205/55 R 16 | 2.35 | 4.4 | 12 | 45.0 | 10 | 1.34 | 9 | F |
| 5 | 205/55 R 16 | 2.37 | 4.7 | 12 | 25.0 | 10 | 1.34 | 19 | R |
| 6 | 185/55 R 15 | 2.35 | 4.4 | 12 | 56.0 | 3 | 1.34 | 24 | R |
| 7 | 205/65 R 15 | 2.39 | 4.3 | 12 | 54.0 | 3 | 1.34 | 24 | R |
| 8 | 195/55 R 16 | 2.37 | 5 | 12 | 25.8 | 3 | 1.34 | 69 | R |

[1] frequency at which the sidewall appearance defect occurs (F: frequent; R: rare)

1. A tire comprising:
two beads configured to come into contact with a mounting rim, each bead comprising at least one annular reinforcing structure, the annular reinforcing structure having, in any radial section, at least one radially innermost point;
two sidewalls extending the beads radially outwards, the two sidewalls joining together in a crown comprising a crown reinforcement and a hooping reinforcement, positioned radially on the outside of the crown reinforcement and surmounted by a tread made of at least one first rubber compound;
a carcass reinforcement extending from the beads through the sidewalls as far as the crown, the carcass reinforcement comprising a plurality of carcass reinforcing elements and being anchored in the two beads by turning back around the annular reinforcing structure so as to form, within each bead, an main portion and a wrapped-around portion;
the tire having a median plane which, in any radial section, divides the tire into two tire halves,
each tire half further comprising at least one outer strip made of at least one second rubber compound and positioned at least partially axially on the outside of the wrapped-around portion of the carcass reinforcement, each outer strip extending radially as far as a radially outer end, DI denoting the radial distance between the radially outer end of the outer strip and the radially innermost point of the annular reinforcing structure;
the tread comprising, in any radial section and in each tire half, at least one radially innermost point, DE denoting the radial distance between this radially innermost point of the tread and the radially innermost point of the annular reinforcing structure;
wherein the crown reinforcement comprises a radially inner layer and a radially outer layer, each of the layers being reinforced with threadlike reinforcing elements, the reinforcing elements in each layer being substantially parallel to one another, the reinforcing elements in the two layers being crossed with respect to one another;
wherein the radially outer layer of the crown reinforcement extends axially, in each radial section, on each side of the median plane of the tire, between two axial ends of the outer layer,
the hooping reinforcement extending axially on each side of the median plane of the tyretire between two axial ends of the hooping reinforcement such that, in each tire half, the axial end of the hooping reinforcement is situated axially on the outside of the axial end of the outer layer;
the sidewall comprising, in each tire half, a first sidewall part located at radial distances that are greater than or equal to DI and less than or equal to DE from the radially innermost point of the annular reinforcing structure, said first sidewall part being made of at least one third rubber compound distinct from said at least one first and second rubber compounds from which the tread and said outer strip are made, said at least one third rubber compound having an elastic modulus E greater than or equal to 1.5 MPa and less than or equal to 10 MPa;
the sidewall having, in said first sidewall part, a mean thickness EA, this thickness being measured perpendicular to the carcass reinforcement;
the hooping reinforcement being made of a textile material having a shrinkage force FC at 180° C. that is less than or equal to 12 N, the hooping reinforcement being formed of at least one reinforcing element directed circumferentially, the hooping reinforcement having, in any radial section, a plurality of inter-sections with the plane of section such that, in each tyretire half, a non-zero number NC of intersections is situated axially on the outside of the axial end of the outer layer of the crown reinforcement;
wherein the elastic modulus E, the mean thickness EA, the number of intersections NC and the shrinkage force FC at 180° C. are chosen such that for each sidewall of the tire, the following inequality is satisfied:
where P is the thickness of the tire measured in a direction perpendicular to the carcass reinforcement and having an intersection with the axial end of the outer layer of the crown reinforcement which lies in the same tire half as the sidewall, and where B is the curvilinear length of the carcass reinforcement between (a) a point on the carcass reinforcement that is at a distance DI with respect to the radially innermost point of the annular reinforcing structure, and (b) a point on the carcass reinforcement that is at a distance DE with respect to the radially innermost point of the annular reinforcing structure.

2. The tire of claim 1, wherein the elastic modulus E, the mean thickness EA, the number of intersections NC, and the shrinkage force FC at 180° C. are chosen such that for each sidewall of the tyretire, K<11.

3. The tire of claim 1, wherein the elastic modulus E is less than or equal to 3 MPa.

4. The tire of claim 1, wherein the mean thickness EA is greater than or equal to 2 mm and less than or equal to 5 mm.

5. The tire of claim 1, wherein the number of intersections NC is greater than or equal to 3 and less than or equal to 15.

6. The tire of claim 1, wherein the thickness P of the tire is greater than or equal to 8 mm and less than or equal to 15 mm.

7. The tire of claim 1, wherein the hooping reinforcement is made of polyester.

8. The tire of claim 7, wherein the hooping reinforcement is made of PET (polyethylene terephthalate).

9. The tire of claim 7, wherein the hooping reinforcement is made of PEN (polyethylene naphthalate).

10. The tire of claim 7, wherein the hooping reinforcement is made of PK (polyketone).

11. The tire of claim 1, wherein the shrinkage force FC at 180° C. of the material of which the hooping reinforcement is made is greater than or equal to 3 N and less than or equal to 9 N.

12. The tire of claim 1, wherein the force developed at 180° C. at 3% deformation of the material from which the hooping reinforcement is made is greater than or equal to 25 N.
